(19) United States
(12) Patent Application Publication
(10) Pub. No.: US 2015/0268728 A1
(43) Pub. Date: Sep. 24, 2015

(54) SYSTEMS AND METHODS FOR NOTIFYING USERS OF MISMATCHES BETWEEN INTENDED AND ACTUAL CAPTURED CONTENT DURING HEADS-UP RECORDING OF VIDEO

(71) Applicant: FUJI XEROX CO., LTD., TOKYO (JP)

(72) Inventors: Ville Mikael Mäkelä, Tampere (FI); Scott Carter, Mountain View, CA (US); Matthew L. Cooper, San Francisco, CA (US); Vikash Rugoobur, San Jose, CA (US); Laurent Denoue, Verona (IT); Sven Kratz, San Jose, CA (US)

(73) Assignee: FUJI XEROX CO., LTD., TOKYO (JP)

(21) Appl. No.: 14/218,495

(22) Filed: Mar. 18, 2014

(51) Int. Cl. G06F 3/01; G02B 27/01

(52) U.S. Cl. CPC G06F 3/017; G02B 27/017; G02B 2027/0178

(57) ABSTRACT

A computerized system and computer-implemented method for assisting a user with capturing a video of an activity. The system incorporates a central processing unit, a camera, a memory and an audio recording device. The computer-implemented method involves: using the camera to capture the video of the activity; using the central processing unit to process the captured video, the processing comprising determining a number of user's hands appearing in the captured video; using the recording device to capture of the audio associated with the activity; using the central processing unit to process the captured audio, the processing comprises determining a number of predetermined references in the captured audio; using the determined number of user's hands appearing in the captured video and the determined number of predetermined references in the captured audio to generate feedback to the user; and providing the generated feedback to the user using a notification.

### BACKGROUND OF THE INVENTION

1. Technical Field

The disclosed embodiments relate in general to techniques for assisting users with content capture and, more specifically, to systems and methods for notifying users of mismatches between intended and actual captured content during heads-up recording of expository video.

2. Description of the Related Art

Capturing video with a heads-up display can appear easy and simple, as users often assume that the camera located right above their eyes would simply record everything they are seeing. However, this is often not the case due to the fact that the camera has more narrow field of view compared to the human eye. In addition, the camera may often be oriented at a slightly different angle and as the result an object that the user is holding in the middle of his field of view might appear on the edge or even outside the field of view of the camera.

Therefore, to acquire a high quality expository video, the user needs to remember to regularly check the camera's view and adjust it accordingly. Unfortunately, this makes it more difficult for the user to focus on the actual task being recorded. In fact, when capturing how-to content with heads-up displays users often shift their attention away from the region being captured. This happens when the users become engrossed in a task but forget to check whether their head is pointing at the action they are filming.

Therefore, it would be advantageous to have systems and methods that would notify users of mismatches between intended and actual captured content during heads-up recording of expository videos.

### SUMMARY OF THE INVENTION

The embodiments described herein are directed to methods and systems that substantially obviate one or more of the above and other problems associated with conventional techniques for capturing video content.

In accordance with one aspect of the inventive concepts described herein, there is provided a computer-implemented method for assisting a user with capturing a video of an activity, the method being performed in a computerized system incorporating a central processing unit, a camera, a memory and an audio recording device, the computer-implemented method involving: using the camera to capture the video of the activity; using the central processing unit to process the captured video, the processing comprising determining a number of user's hands appearing in the captured video; using the recording device to capture of the audio associated with the activity; using the central processing unit to process the captured audio, the processing comprises determining a number of predetermined references in the captured audio; using the determined number of user's hands appearing in the captured video and the determined number of predetermined references in the captured audio to generate feedback to the user; and providing the generated feedback to the user using a notification.

In one or more embodiments, the computerized system further incorporates a display device and wherein the generated feedback is provided to the user by displaying the generated feedback on the display device.

In one or more embodiments, the computerized system further incorporates a display device, the display device displaying a user interface, the user interface including a live stream of the capturing video and the generated feedback interposed over the live stream.

In one or more embodiments, the computerized system further incorporates an audio playback device and wherein the generated feedback is provided to the user using the audio playback device.

In one or more embodiments, the processing of the captured audio involves performing speech recognition in connection with the captured audio.

In one or more embodiments, the feedback includes the determined number of user's hands appearing in the captured video.

In one or more embodiments, the feedback includes an indication of an absence of the predetermined references in the captured audio.

In one or more embodiments, the feedback includes an indication of an absence of user's speech in the captured audio.

In one or more embodiments, the method further involves determining a confidence level of the determination of the number of user's hands appearing in the captured video, wherein a strength of the notification is based on the determined confidence level.

In one or more embodiments, the processing of the captured audio involves performing a speech recognition in connection with the captured audio and the method further involves determining a confidence level of the speech recognition, wherein a strength of the notification is based on the determined confidence level.

In one or more embodiments, when it is determined that no user's hands appear in the captured video, the feedback includes a last known location of at least one of the user's hands.

In one or more embodiments, when it is determined that no user's hands appear in the captured video, the feedback includes an indication of absence of user's hands in the captured video.

In one or more embodiments, when it is determined that no user's speech is recognized in the captured audio, the feedback includes an indication of absence of user's speech in the captured audio.

In one or more embodiments, when it is determined that no user's hands appear in the captured video and user's speech is recognized in the captured audio, the feedback includes an enhanced indication of absence of user's hands in the captured video.

In one or more embodiments, when it is determined that at least one of user's hands appears in the captured video and no user's speech is recognized in the captured audio, the feedback includes an enhanced indication of absence of user's speech in the captured audio.

In one or more embodiments, the camera is a depth camera producing depth information and the number of user's hands appearing in the captured video is determined based, at least in part, on the depth information produced by the depth camera.

In one or more embodiments, determining the number of user's hands appearing in the captured video involves: applying a distance threshold to the depth information produced by the depth camera; performing a Gaussian blur transformation of the thresholded depth information; applying a binary threshold to the blurred depth information; finding hand contours; and marking hand centroids from the found hand contours.

In one or more embodiments, the determining the number of user's hands appearing in the captured video further involves marking hand sidedness.

In one or more embodiments, the determining the number of user's hands appearing in the captured video further involves estimating fingertip positions.

In one or more embodiments, the estimating fingertip positions involves: finding a convex hull of each hand contour; determining convexity defect locations; computing k-Curvature for each defect; determining a set of fingertip position candidates and clustering the fingertip position candidates to estimate the fingertip positions.

In accordance with another aspect of the inventive concepts described herein, there is provided a non-transitory computer-readable medium embodying a set of computer-executable instructions, which, when executed in a computerized system incorporating a central processing unit, a camera, a memory and an audio recording device, cause the computerized system to perform a method for assisting a user with capturing a video of an activity, the method involving: using the camera to capture the video of the activity; using the central processing unit to process the captured video, the processing comprising determining a number of user's hands appearing in the captured video; using the recording device to detect an audio associated with the activity; and providing a feedback to the user when the determined number of user's hands decreases while the audio continues to be detected.

In accordance with yet another aspect of the inventive concepts described herein, there is provided a computerized system for assisting a user with capturing a video of an activity, the computerized system incorporating a central processing unit, a camera, a memory and an audio recording device, the memory storing a set of instruction for: using the camera to capture the video of the activity; using the central processing unit to process the captured video, the processing comprising determining a number of user's hands appearing in the captured video; using the recording device to capture of the audio associated with the activity; using the central processing unit to process the captured audio, the processing comprises determining a number of predetermined references in the captured audio; using the determined number of user's hands appearing in the captured video and the determined number of predetermined references in the captured audio to generate feedback to the user; and providing the generated feedback to the user using a notification.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates an exemplary embodiment of a computerized system for assisting a user with capturing audio/video content and for providing notifications to the user of apparent mismatches between intended and actual captured content.

FIG. 2 illustrates an exemplary embodiment of the integrated audio/video capture and heads-up display device.

FIG. 3 illustrates an exemplary embodiment of a graphical user interface displayed on the heads-up display of the integrated audio/video capture and heads-up display device.

FIG. 4 illustrates an exemplary embodiment of user's point-of-view.

FIG. 5 illustrates an exemplary operating sequence of the computerized system for assisting a user with capturing audio/video content and for providing notifications to the user of apparent mismatches between intended and actual captured content.

FIG. 6 illustrates exemplary screenshots of the graphical user interface displayed to the user using the heads-up display.

FIG. 7 illustrates exemplary embodiments of situational system feedback.

FIG. 8 illustrates an exemplary operating sequence of an embodiment of a hand tracking method.

FIG. 9 illustrates an exemplary operating sequence of a method for determining the hand sidedness.

FIG. 10 illustrates an exemplary operating sequence of a method for fingertip detection based on convexity defects and k-curvature.

FIG. 11 illustrates an exemplary output of the hand tracking process at different stages of its operation.

FIG. 12 illustrates an exemplary embodiment of a computerized system for assisting a user with capturing audio/video content and for providing notifications to the user of apparent mismatches between intended and actual captured content.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

It has been observed that when capturing expository content with a heads-up system the user's hands are likely to be involved in the activity that the user intends to record. This fact is especially true for table-based activities. Based on this observation, an embodiment of an automated system described herein is configured to make assumptions on whether or not something important activity is missing from the recording when user's hands are not present within the field of view of the camera.

Thus, in accordance with one or more aspects of the embodiments described herein, a heads-up video capture system is augmented with a depth camera to track the location of the user's hands and provide feedback to the user in the form of visual or audio notifications. In one or more embodiments, the notification intensity may depend on other features that can be sensed at the time of recording. In particular, a speech analysis engine may be provided to analyze user's speech during content capture and detect when the user is referring to objects vocally with predetermined domain-specific words (e.g., “this”, “that”, “put”, “place”, “move”). When the system detects both that hands are not present and that reference words are being used it is configured to present a more conspicuous and/or distracting notification to the user than it would if it detected only the lack of hands within the camera view.

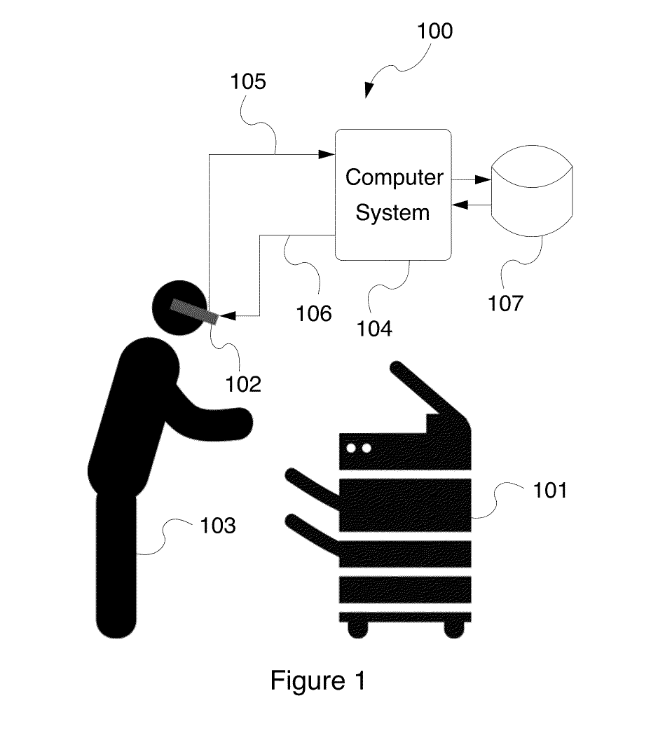

FIG. 1 illustrates an exemplary embodiment of a computerized system 100 for assisting a user with capturing audio/video content and for providing notifications to the user of apparent mismatches between intended and actual captured content. The computerized system 100 may be used for capturing various types of audio/video content, including, for example, expository videos such as a usage tutorial in connection with equipment or other article 101. The system 100 incorporates an integrated audio/video capture and heads-up display device 102 worn by the user 103. In one or more embodiments, the integrated audio/video capture and heads-up display device 102 may be implemented based on an augmented reality head-mounted display (HMD) systems, such as Google glass, well known to persons of ordinary skill in the art.

In one or more embodiments, the integrated audio/video capture and heads-up display device 102 is connected, via a data link, to a computer system 104, which may be integrated into the device 102 or implemented as a separate stand-alone computer system. During the capture of the audio/video content by the user, the integrated audio/video capture and heads-up display device 102 sends the captured content 105 to the computer system 104 via a data link. In one or more embodiments, the data link may be a wireless data link operating in accordance with any known wireless protocols, such as WIFI or Bluetooth or a wired data link.

The computer system 104 receives the captured content 105 from the integrated audio/video capture and heads-up display device 102 and processes it in accordance with the techniques described herein. Specifically, the captured content 105 is used by the computer system 104 to determine whether the actually captured content matches the content that the user intends to capture. In case of a mismatch, a warning message 106 is generated by the computer system 104 and sent to the integrated audio/video capture and heads-up display device 102 via data link for display to the user. The computer system 104 is further configured to store the received captured content 105 in the content storage 107 for subsequent retrieval. The content storage 107 may be implemented based on any now known or later developed data storage system, such as database management system, a file storage system, or the like.

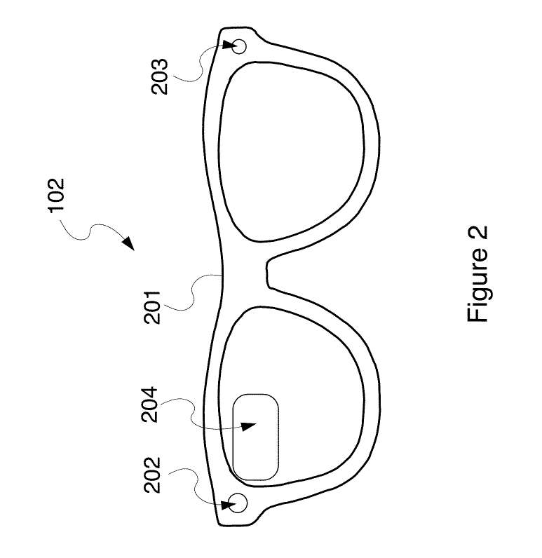

FIG. 2 illustrates an exemplary embodiment of the integrated audio/video capture and heads-up display device 102. The integrated audio/video capture and heads-up display device 102 incorporates a frame 201, a display 204 an audio capture (recording) device 203 and a camera 202. In one or more embodiments, the camera 202 optionally includes a depth-sensor. In one or more embodiments, the audio capture device 203 may be a microphone. The heads-up display 204 shows a preview of the content currently being recorded using the camera 202 and audio recorder 203 and provides a real-time feedback to the user. In one or more embodiments, the integrated audio/video capture and heads-up display device 102 may further incorporate an audio playback device (not shown) for providing an audio feedback to the user, such as a predetermined sound or melody.

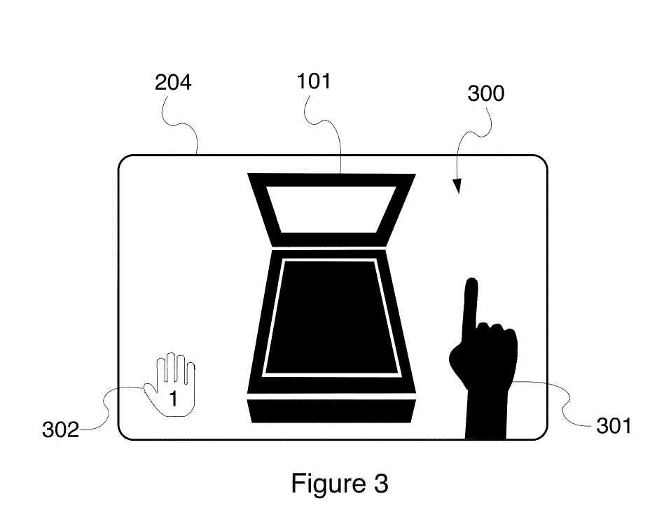

FIG. 3 illustrates an exemplary embodiment of a graphical user interface 300 displayed on the heads-up display 204 of the integrated audio/video capture and heads-up display device 102. The user interface 300 includes a live video of the video content being recorded using the camera 202. In the example shown in FIG. 3, the live video depicts the equipment or other article 101 as well as one of user's hands 301. The graphical user interface 300 may further include one or more notification elements 302 providing the user with the real-time feedback in connection with the content being currently recorded by the user. In the shown example, the notification element 302 is a hand-shaped icon having a superimposed numeral (1) indicating the number of user's hands currently recognized in the real-time video content.

In one or more embodiments, the system 100 is configured to produce automatic, peripheral visual feedback based on how many hands it recognizes in the recorded video content at any given moment. The system highlights hands it recognizes and displays the icon 302 with the number of hands (1) in the corner with sounds played when a hand appears on or disappears from the screen. Furthermore, in one or more embodiments, the feedback is affected by the user's speech. To this end, the speech recognition is performed using the real-time audio recorded by the audio recorder 203. As would be appreciated to persons or ordinary skill in the art, references to objects with reference words often hint that one or more hands should be visible on the screen. If this is not the case, the system 100 is configured to provide more noticeable feedback to the user.

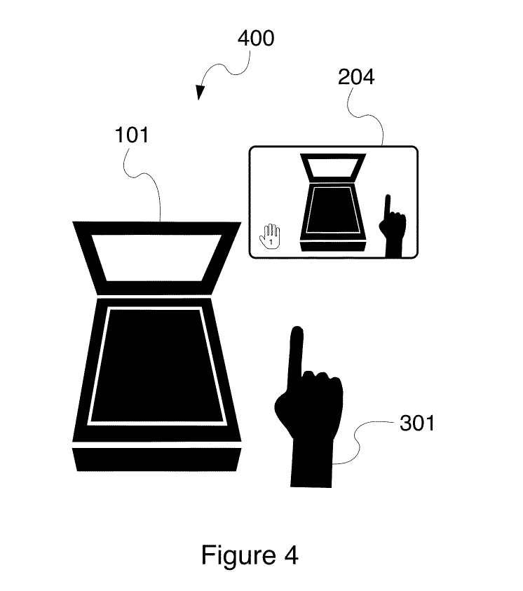

FIG. 4 illustrates an exemplary embodiment of user's point-of-view 400. The heads-up display 204 providing the user with the real-time feedback appears in the upper right corner of the user's view. In addition, the exemplary user's view 400 includes the equipment or other article 101 and one of his hands 301.

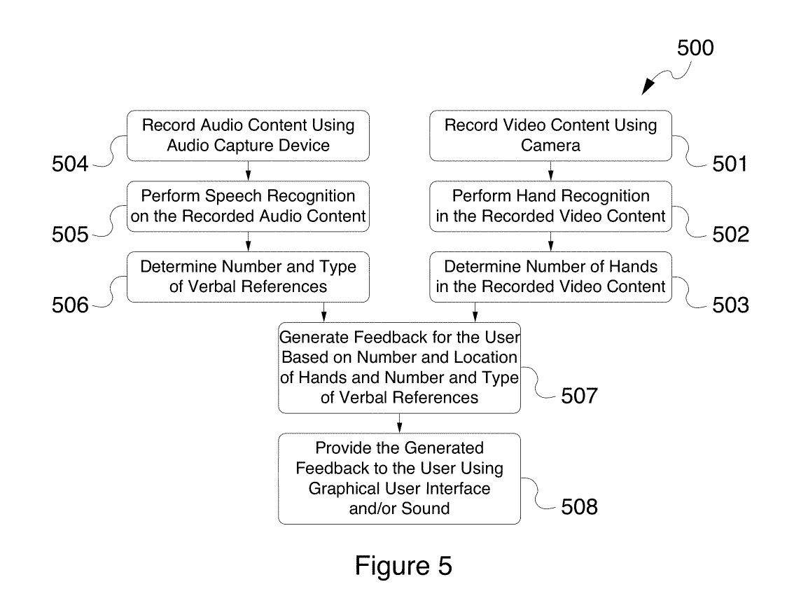

FIG. 5 illustrates an exemplary operating sequence 500 of the computerized system 100 for assisting a user with capturing audio/video content and for providing notifications to the user of apparent mismatches between intended and actual captured content. At step 501, the system 100 records real-time live video content using the camera 202. At step 502, hand recognition is performed in the recorded video content in accordance with the techniques described in detail below. At step 503, the number of hands appearing in the recorded video content is determined based on the output of the hand recognition procedure 502. At step 504, a live audio content is being recorded using the audio recording device (microphone) 203. At step 505, a speech recognition operation is performed on the recorded live audio content. At step 506, the number and type of verbal references to objects is determined using the results of the speech recognition operation 505. In one or more embodiments, the steps 501-503 and 504-506 may be performed in a parallel manner. At step 507, a feedback to the user is generated based on the number and location of hands detected in the recorded video content as well as number and type of verbal references detected in the recorded audio content. Finally, at step 508, the generated feedback is provided to the user using the graphical user interface 300 displayed on the heads-up display 204 and/or audio playback device of the integrated audio/video capture and heads-up display device 102.

In one embodiment of the invention, user's hands are tracked using frames from the video recorded by the camera 202. As well known to persons of ordinary skill in the art, there exist many off-the-shelf techniques and toolkits for building hand trackers from single cameras. Any of these well known techniques can be used for hand tracking of the user using the captured video content. In another embodiment of the invention, the system 100 uses a head-mounted depth camera for hand tracking. The aforesaid depth camera may be mounted on the same frame 201 shown in FIG. 2 as an alternative or in addition to the camera 202. This hand tracking approach utilizes a computer vision method to extract hand contours, hand positions and fingertip positions from the depth camera's stream of depth images, as will be described in detail below. With the depth information supplied by the depth camera, the hand tracking is far more robust than with a camera-only input. For example, with additional depth information the tracker would be more likely to accurately track a hand that is gloved or gripping a tool.

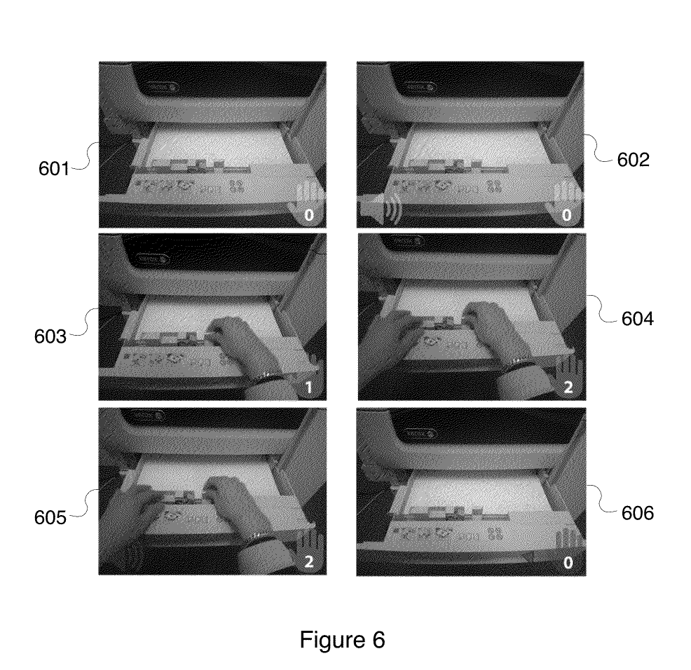

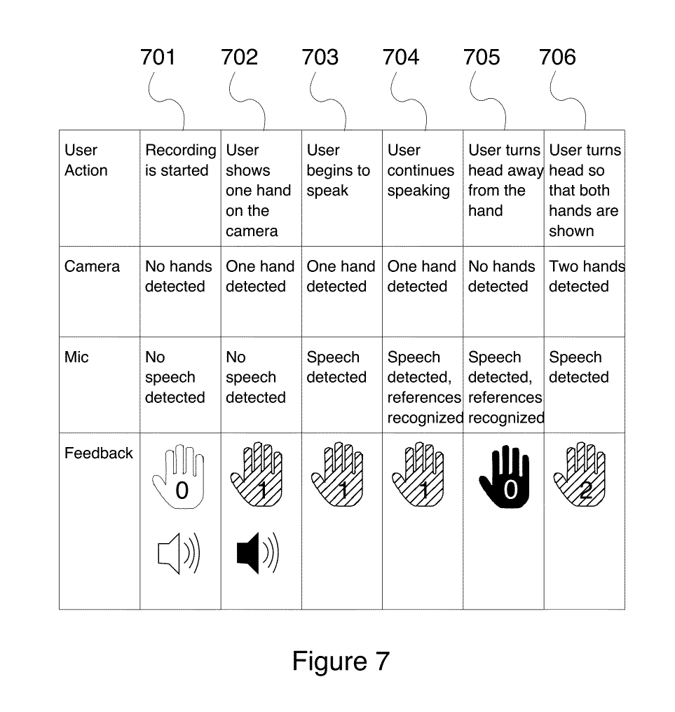

Given the results of the audio and depth analysis components, there are multiple ways to create notifications for the user. The basic assumption used in one or more embodiments described herein is that in segments when the hands or other object motion is detected, there is likely to be activity that can be narrated to improve the video. If audio, referential or activity-specific keywords are detected in the absence of detecting the hands or object motion, the system 100 is configured to provide a visual cue that the activity may be outside the camera's field of view. This case is illustrated in the graphical user interface screenshots 601 and 606 shown in FIG. 6 as well as situation 705 of FIG. 7.

Conversely, when the system 100 detects motion or detects hands in the absence of the speech over an extended shot, the system 100 is configured to cue the user with an audio icon. The idea behind this cue is to encourage narration or possibly to remind the users that they may be inadvertently capturing unnecessary content. This case is illustrated in the graphical user interface screenshot 605 shown in FIG. 6, as well as situation 702 of FIG. 7. It should be noted that in both cases the feedback can be additionally or alternatively provided to the user in the form of audio notifications.

FIG. 6 illustrates exemplary screenshots of the graphical user interface 300 displayed to the user using the heads-up display 204. In the exemplary graphical user interface screenshot 601, no hands are recognized but audio is being detected. To this end, the numeral superimposed over the hand icon on the right indicates “0” recognized hands. In the exemplary screenshot 602, neither hands nor speech is detected. Therefore, in addition to the hand icon with a superimposed numeral “0” indicating no present hands, an audio icon is displayed in the left bottom corner of the user interface 300. In the exemplary screenshot 603, one hand appears on the screen, as indicated using a hand icon with a superimposed numeral “1” and audio is also present, as indicated by the absent audio icon. In the exemplary screenshot 604, two hands appear on the screen, as indicated using a hand icon with a superimposed numeral “2”, and audio is also present, as indicated by the absent audio icon. In the exemplary screenshot 605, two hands are recognized, as indicated using a hand icon with a superimposed numeral “2”, but no speech is detected. Thus, an audio icon is displayed in the left. Finally, in the exemplary screenshot 606, both hands disappear from the screen but audio is being detected, as indicated by the absent audio icon. In this situation, a hand icon has numeral “0” superimposed over it, indicating that no hands are present in the recorded video. In one or more embodiments, an arrow points to the last observed location of a hand.

FIG. 7 illustrates exemplary embodiments of situational system feedback. In situation 701, generally corresponding to the aforesaid screenshot 602, the user starts recording and neither hands nor speech is detected. Therefore, the hand icon with a superimposed numeral “0” is displayed, indicating no present hands, as well as an audio icon. In situation 702, one hand appears on the screen, as indicated using a hand icon with a superimposed numeral “1” and audio is not present, as indicated by the audio icon. In one or more embodiments, in this situation, the audio icon may be displayed in a conspicuous color, such as red. On the other hand, the hand icon may be displayed in a less conspicuous color, such as yellow.

In situation 703, when user begins to speak, one hand appears on the screen, as indicated using a hand icon with a superimposed numeral “1” and audio is also present, as indicated by the absent audio icon. In situation 704, the user continues to speak and one hand appears on the screen, as indicated using a hand icon with a superimposed numeral “1” and audio is also present with the system recognizing predetermined references in the user's speech. Thus, the audio icon is not displayed.

In situation 705, the user turns his head away from his hand and no hands are detected in the recorded video. On the other hand, the speech is detected and the references to the objects are recognized. In this situation, the system is configured to display the hand icon with a superimposed numeral “0” indicating no present hands. Because the speech is detected, the audio icon is not displayed. In one or more embodiments, in this situation, the hand icon may be displayed in a conspicuous color, such as red.

In situation 706, the user turns his head such that both hands are shown in the recorded video. The speech is also being detected. In this situation, the system is configured to display the hand icon with a superimposed numeral “2” indicating two recognized hands. Because the speech is detected, the audio icon is not displayed.

In one or more embodiments, the audio analysis of the user's speech recorded by the audio recording device may be performed at two granularities. First, the speech (of the creator) is discriminated from non-speech segments, with the assumption that the final video will consist predominantly of narrated shots. There are a variety of existing methods well known to persons of ordinary skill in the art for implementing such a speech discrimination operation, typically based on thresholding the detected energy in the frequency bands of human speech. The head mounted microphone 203 improves the reliability of these methods.

In one or more embodiments, the second level of audio analysis detects a pre-determined set of keywords that are identified to be referential or otherwise associated with narration of the user's activity. While automatic keyword spotting is challenging, the performance of the keyword detection process benefits from the presence of the head mounted microphone 203 and the employment of the dedicated speaker modeling to adapt its ASR system to the device owner's voice.

In one or more embodiments, the set of keywords detected in the recorded audio content corresponds to those keywords that are correlated with how-to and tutorial content. These include the word “step”, ordinal numbers, words suggesting a sequence (“now”, “after”, “then”, “when”), reference words (“this”, “that”, “there”), as well as transitive verbs (“turn”, “put”, “place”, “take”, “put”, etc.).

An exemplary embodiment of the hand tracker usable in connection with the described computerized system 100 for assisting a user with capturing audio/video content and for providing notifications to the user of apparent mismatches between intended and actual captured content will now be described. In one or more embodiments, a head-mounted depth sensor is used to provide additional input capabilities to assists the computerized system 100 in tracking user's hand positions as well as their movements. In one or more embodiments, the hand tracker is configured to convert a stream of depth images captured by the depth sensor into tracking information that can be used by the computerized system 100 for generating the user feedback notifications described above.

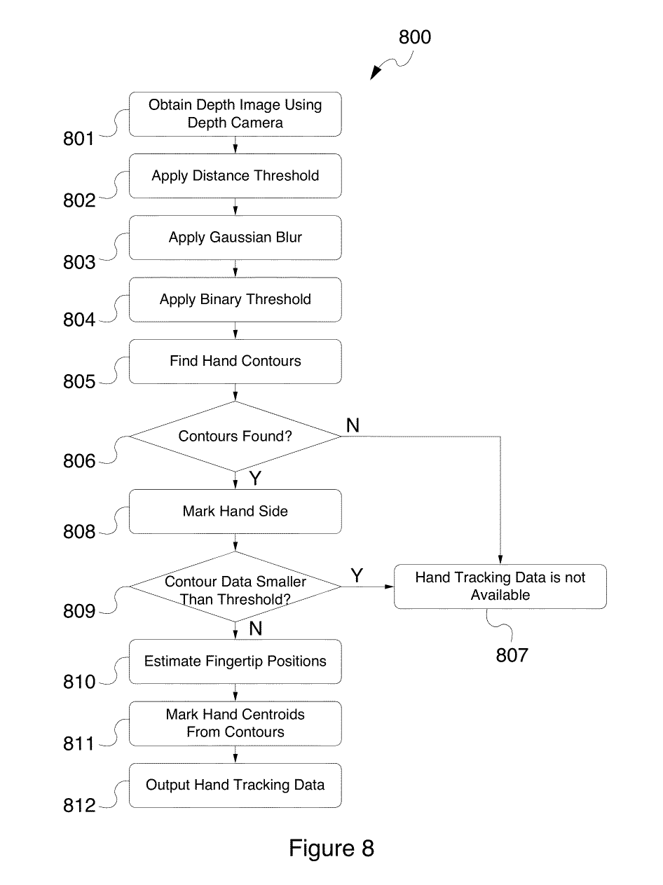

In one or more embodiments, the hand tracking information provided by the hand tracker comprises hand center locations, hand sidedness and fingertip locations. The location information may comprise image x and y coordinates as well as a depth value. FIG. 8 illustrates an exemplary operating sequence of an embodiment of a hand tracking method 800. First, at step 801, one or more depth images are obtained using the depth camera. The depth images contain, in addition or in the alternative to the color information of the conventional images, the information on the distance of the surfaces of the scene objects from the image-capturing camera.

At step 802, a predetermined distance threshold is applied to the image depth information to select image objects within a predetermined distance range from the depth camera. At step 803, a Gaussian blur transformation is applied to the thresholded depth image, resulting in the reduction of the image noise and image detail. At step 804, a binary threshold is applied. At step 805, the system attempts to find hand contours in the image. If it is determined at step 806 that hand contours cannot be located in the image, then the process 800 terminates with the output indicating that the tracking data is not available, see step 807.

If it is determined at step 806 that the hand contours are present in the image, the hand side (right or left) is marked at step 808. At step 809, the system checks whether the contour data is smaller than a threshold. If so, the process 800 terminates with the output indicating that the tracking data is not available, see step 807. Otherwise, the operation proceeds to step 810, wherein the fingertip positions are estimated. Subsequently, at step 811, hand centroids are marked from the previously determined hand contours. Finally, the hand tracking data is output at step 812.

As would be appreciated by persons of ordinary skill in the art, the method 800 shown in FIG. 8 addresses two particular problems:

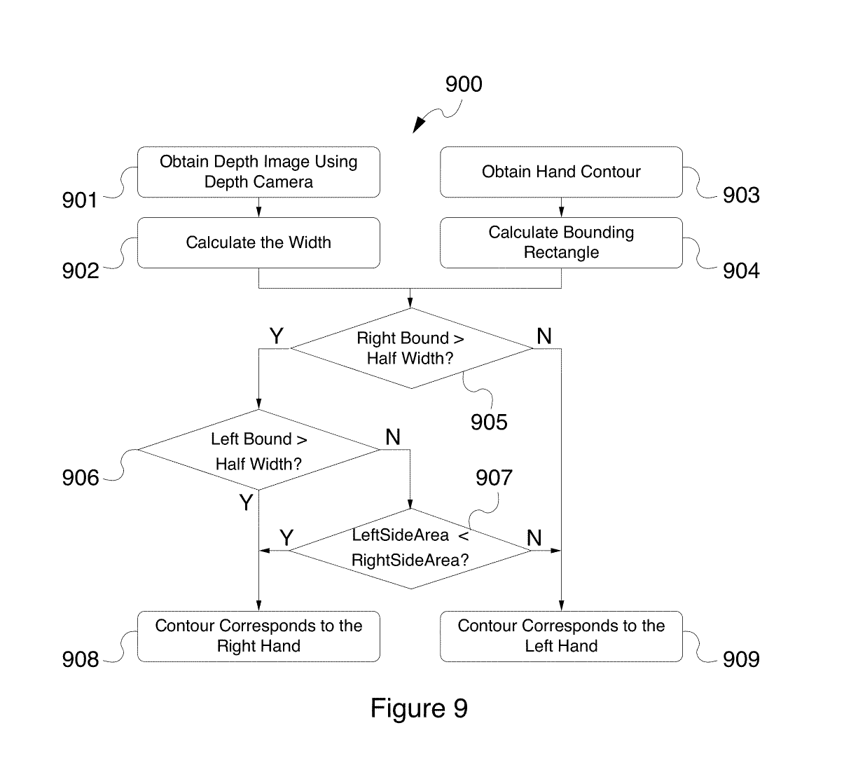

(1) Determining if a given contour belongs to the left or right hand of the user (hand sidedness). This determination method is based on the ratio of the area of a contour that lies within the left half of the image compared to the area of the contour that lies within the right side. An exemplary operating sequence of this method is illustrated in FIG. 9.

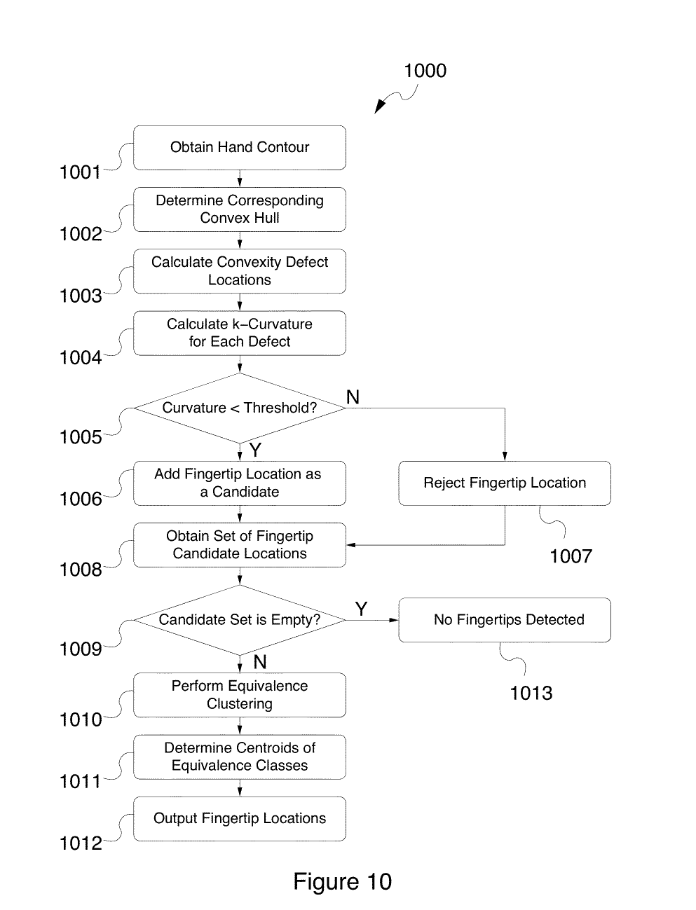

(2) Determining finger tip locations based on analyzing the contour k-Curvature, as described, for example, in T. R. Trigo and S. R. M. Pellegrino, “An Analysis of Features for Hand-Gesture Classification,” in 17th International Conference on Systems, Signals and Image Processing (IWSSIP 2010), 2010, pp. 412-415, as well as convexity defects. Because this method can produce multiple candidates for fingertips, groups of candidate fingertip locations are clustered using an algorithm similar to the DBSCAN technique described in detail in M. Ester, H. Kriegel, J. S, and X. Xu, “A density-based algorithm for discovering clusters in large spatial databases with noise,” 1996, pp. 226-231, in order to obtain consistent results. An exemplary operating sequence of this method is illustrated in FIG. 10.

FIG. 9 illustrates an exemplary operating sequence of a method 900 for determining the hand sidedness, as used in the step 808 of the process 800 shown in FIG. 8. Specifically, at step 901, a depth image is obtained using the depth camera. At step 902, the width of the depth image is calculated. At step 903, a hand contour is obtained from, for example, step 805 of the process 800 shown in FIG. 8. At step 904, a bounding rectangle is obtained for the hand contour. At step 905, it is determined whether the right bound of the bounding rectangle is greater than the half width of the depth image. If so, the operation is transferred to step 906. Otherwise, the process 1000 determines that the hand contour corresponds to the left hand, see step 909.

At step 906, the system determines whether the left bound of the bounding rectangle is greater than the half width of the depth image. If so, the process 1000 determines that the hand contour corresponds to the right hand, see step 908. Otherwise, the operation is transferred to step 907, whereupon it is determined whether left side area of the bounding rectangle is smaller than the right side area thereof. If so, the process 1000 determines that the hand contour corresponds to the right hand, see step 908. Otherwise, the process 1000 determines that the hand contour corresponds to the left hand, see step 909. Subsequently, the process 900 terminates.

FIG. 10 illustrates an exemplary operating sequence of a method 1000 for fingertip detection based on convexity defects and k-curvature. Specifically, at step 1001, a hand contour is obtained from, for example, step 805 of the process 800 shown in FIG. 8. At step 1002, the corresponding convex hull is determined using techniques well known to persons of ordinary skill in the art. At step 1003, the convexity defect locations are calculated. At step 1004, k-Curvature value is calculated for each found convexity defect. At step 1005, the calculated k-Curvature value is compared with a predetermined threshold. If the k-Curvature value is less then the predetermined threshold value, then the fingertip location is added as a candidate, see step 1006. Otherwise, the corresponding fingertip location is rejected, see step 1007, and the operation is transferred to step 1008. At step 1008, the set of fingertip candidate locations is obtained. At step 1009, it is determined whether the obtained set of fingertip candidate locations is empty. If so, the process 1000 terminates with the output indicating that no fingertips have been detected, see step 1013. Otherwise, equivalence clustering is performed at step 1010. Subsequently, at step 1011, centroids of the equivalence classes are determined. Finally, at step 1012, the fingertip locations are output and the process 1000 terminates.

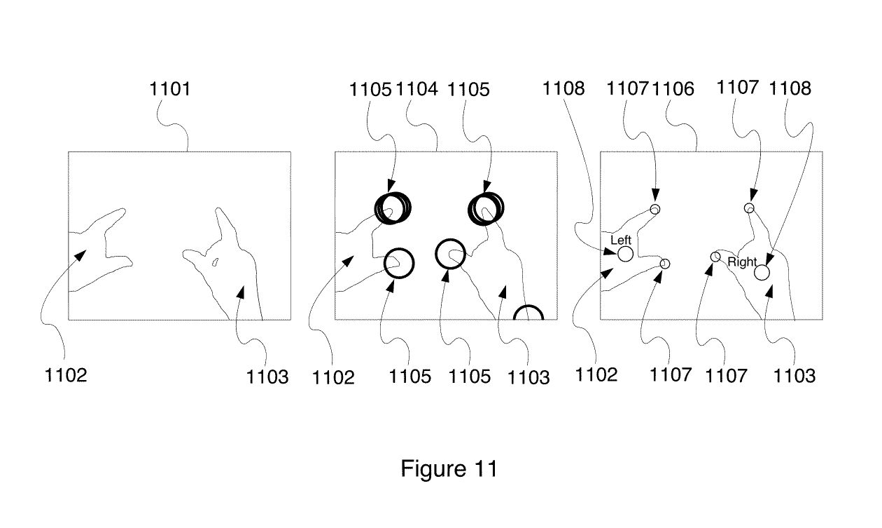

FIG. 11 illustrates an exemplary output of the hand tracking process 800 at different stages of its operation. Specifically, an exemplary output 1101 illustrates the depth image after the thresholding operation, see step 802 of the process 800. Very clear hand contours 1102 and 1103 corresponding to the left hand and right hand, respectively, can be seen. Exemplary output 1104 corresponds to the image after the contour detection operation and the determination of the fingertip candidates. As can be seen from the output 1104, the system assigns multiple fingertip candidates 1105 at several locations, necessitating the subsequent clustering stage. Finally, an exemplary output 1106 illustrates the final output of the process 800 with the detected fingertip locations 1107, hand centroids 1108 and hand sidedness (left or right).

It should be noted that in the context of the computerized system 100 for assisting a user with capturing audio/video content and for providing notifications to the user of apparent mismatches between intended and actual captured content, the described hand tracking method 800 may be used for a variety of purposes, such as for determining user hand presence within the recorded video, as well as for enabling a gesture-based user interface usable, for example, for video recording control. Exemplary gestures that could be recognized using the described hand tracking method 800 include, without limitation, pinch-zoom in the field of view while recording video, marking a region of interest, marking a time of interest (e.g., adding a bookmark through a gesture). In various embodiments, marks could include standard bookmarks, annotations, or signals that a section of video should be removed or a section of audio should be re-recorded. In various embodiments, the gestures recognized using the hand tracking method 800, may implement the basic video controls, such as stop, record and pause.

In addition, the method 800 may be used to facilitate pointing at remote objects, such as smart objects, large display walls, or other users of head-mounted displays. Yet further applications may include learning sign language, providing support when learning musical instruments (e.g. providing feedback about proper posture) and providing feedback for sports activities (e.g. proper hand positioning for goal keeping or shooting pool). As would be appreciated by persons of ordinary skill in the art, the above-enumerated applications of the hand tracking method 800 are not limiting and many other deployments of the method 800 are similarly possible.

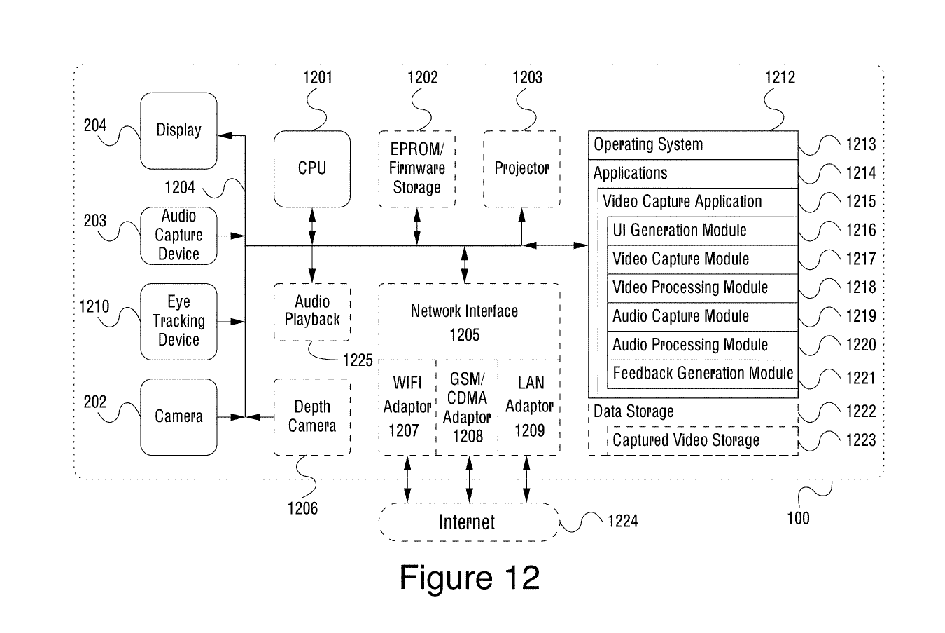

FIG. 12 illustrates an exemplary embodiment of a computerized system 100 for assisting a user with capturing audio/video content and for providing notifications to the user of apparent mismatches between intended and actual captured content. In one or more embodiments, the entire computerized system 100 or a portion thereof may be implemented within the form factor of a desktop computer well known to persons of skill in the art. In an alternative embodiment, the entire computerized system 100 or a portion thereof may be implemented based on a laptop or a notebook computer. Yet in an alternative embodiment, the computerized system 100 may be an embedded system, incorporated into an electronic device with certain specialized functions. Yet in an alternative embodiment, the computerized system 100 may be implemented as a part of an augmented reality head-mounted display (HMD) systems, also well known to persons of ordinary skill in the art.

The computerized system 100 may include a data bus 1204 or other interconnect or communication mechanism for communicating information across and among various hardware components of the computerized system 100, and a central processing unit (CPU or simply processor) 1201 electrically coupled with the data bus 1204 for processing information and performing other computational and control tasks. Computerized system 100 also includes a memory 1212, such as a random access memory (RAM) or other dynamic storage device, coupled to the data bus 1204 for storing various information as well as instructions to be executed by the processor 1201. The memory 1212 may also include persistent storage devices, such as a magnetic disk, optical disk, solid-state flash memory device or other non-volatile solid-state storage devices.

In one or more embodiments, the memory 1212 may also be used for storing temporary variables or other intermediate information during execution of instructions by the processor 1201. Optionally, computerized system 100 may further include a read only memory (ROM or EPROM) 1102 or other static storage device coupled to the data bus 1204 for storing static information and instructions for the processor 1201, such as firmware necessary for the operation of the computerized system 100, basic input-output system (BIOS), as well as various configuration parameters of the computerized system 100.

In one or more embodiments, the computerized system 100 may incorporate a display device 204, which may be also electrically coupled to the data bus 1204, for displaying various information to a user of the computerized system 100, such as user interfaces 300 shown in FIG. 3. In an alternative embodiment, the display device 204 may be associated with a graphics controller and/or graphics processor (not shown). The display device 204 may be implemented as a liquid crystal display (LCD), manufactured, for example, using a thin-film transistor (TFT) technology or an organic light emitting diode (OLED) technology, both of which are well known to persons of ordinary skill in the art. In one or more embodiments, instead of or in addition to the display device 204, the computerized system 100 may include a projector or mini-projector 1203 configured to project information, such as the user interface 300, onto a display surface visible to the user, such as user's glasses lenses, which may be manufactured from a semi-transparent material.

In one or more embodiments, the computerized system 100 may further incorporate an audio playback device 1225 electrically connected to the data bus 1204 and configured to deliver the audio feedback alerts to the user. To this end, the computerized system 100 may also incorporate waive or sound processor or a similar device (not shown).

In one or more embodiments, the computerized system 100 may incorporate one or more input devices, such as a device 1210 for tracking eye movements of the user, for communicating direction information and command selections to the processor 1201 and for controlling cursor movement on the display 204. This input device 1210 typically has two degrees of freedom in two axes, a first axis (e.g., x) and a second axis (e.g., y), that allows the device to specify positions in a plane. The computerized system 100 may further incorporate the camera 202 for acquiring still images and video of various objects, as well as a depth camera 1206 for acquiring depth images of the objects, which all may be also coupled to the data bus 1204. The depth images acquired by the depth camera 1206 may be used to track hands of the user in accordance with the techniques described herein.

In one or more embodiments, the computerized system 100 may additionally include a communication interface, such as a network interface 1205 coupled to the data bus 1204. The network interface 1205 may be configured to establish a connection between the computerized system 100 and the Internet 1224 using at least one of a WIFI interface 1207, a cellular network (GSM or CDMA) adaptor 1208 and/or local area network (LAN) adaptor 1209. The network interface 1205 may be configured to enable a two-way data communication between the computerized system 100 and the Internet 1224. The WIFI adaptor 1207 may operate in compliance with 802.11a, 802.11b, 802.11g and/or 802.11n protocols as well as Bluetooth protocol well known to persons of ordinary skill in the art. The LAN adaptor 1209 of the computerized system 100 may be implemented, for example, using an integrated services digital network (ISDN) card or a modem to provide a data communication connection to a corresponding type of telephone line, which is interfaced with the Internet 1224 using Internet service provider's hardware (not shown). As another example, the LAN adaptor 1209 may be a local area network interface card (LAN NIC) to provide a data communication connection to a compatible LAN and the Internet 1224. In an exemplary implementation, the WIFI adaptor 1207, the cellular network (GSM or CDMA) adaptor 1208 and/or the LAN adaptor 1209 send and receive electrical or electromagnetic signals that carry digital data streams representing various types of information.

In one or more embodiments, the Internet 1224 typically provides data communication through one or more sub-networks to other network resources. Thus, the computerized system 100 is capable of accessing a variety of network resources located anywhere on the Internet 1224, such as remote media servers, web servers, other content servers as well as other network data storage resources. In one or more embodiments, the computerized system 100 is configured to send and receive messages, media and other data, including application program code, through a variety of network(s) including the Internet 1224 by means of the network interface 1205. In the Internet example, when the computerized system 100 acts as a network client, it may request code or data for an application program executing on the computerized system 100. Similarly, it may send various data or computer code to other network resources.

In one or more embodiments, the functionality described herein is implemented by computerized system 100 in response to processor 1201 executing one or more sequences of one or more instructions contained in the memory 1212. Such instructions may be read into the memory 1212 from another computer-readable medium. Execution of the sequences of instructions contained in the memory 1212 causes the processor 1201 to perform the various process steps described herein. In alternative embodiments, hard-wired circuitry may be used in place of or in combination with software instructions to implement the embodiments of the invention. Thus, the described embodiments of the invention are not limited to any specific combination of hardware circuitry and/or software.

The term “computer-readable medium” as used herein refers to any medium that participates in providing instructions to the processor 1201 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to the processor 1201 for execution. For example, the instructions may initially be carried on a magnetic disk from a remote computer. Alternatively, a remote computer can load the instructions into its dynamic memory and send the instructions over the Internet 1224. Specifically, the computer instructions may be downloaded into the memory 1212 of the computerized system 100 from the foresaid remote computer via the Internet 1224 using a variety of network data communication protocols well known in the art.

In one or more embodiments, the memory 1212 of the computerized system 100 may store any of the following software programs, applications or modules:

1. Operating system (OS) 1213 for implementing basic system services and managing various hardware components of the computerized system 100. Exemplary embodiments of the operating system 1213 are well known to persons of skill in the art, and may include any now known or later developed server, desktop or mobile operating systems.

2. Applications 1214 may include, for example, a set of software applications executed by the processor 1201 of the computerized system 100, which cause the computerized system 100 to perform certain predetermined functions, such as display the user interface 300 on the display device 204 or detect user's hand(s) presence using the camera 202. In one or more embodiments, the applications 1214 may include an inventive video capture application 1215, described in detail below.

3. Data storage 1222 may include, for example, a captured video content storage 1223 for storing video content captured using the camera 202.

In one or more embodiments, the inventive video capture application 1215 incorporates a user interface generation module 1216 configured to generate the user interface 300 incorporating the feedback notifications described herein using the display 204 and/or the projector 1203 of the computerized system 100. The inventive video capture application 1215 may further include video capture module 1217 for causing the camera 202 to capture the video of the user activity as well as the video processing module 1218 for processing the video acquired by the camera 202 and detecting presence of user's hands in the captured video. In one or more embodiments, the inventive video capture application 1215 may further include audio capture module 1219 for causing the audio capture device 203 to capture the audio associated with the user activity as well as the audio processing module 1220 for processing the captured audio in accordance with the techniques described above.

The feedback generation module 1221 is provided to generate the feedback for the user based on the detected hands in the captured video and the detected user speech and/or specific references to objects in the captured audio. The generated feedback is provided to the user using the display device 204, the projector 1203 and/or the audio playback device 1225.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the computerized system for assisting a user with capturing audio/video content and for providing notifications to the user of apparent mismatches between intended and actual captured content. It is intended that the specification and examples be considered as exemplary only, with a true scope and spirit of the invention being indicated by the following claims.

What is claimed is:

1. A computer-implemented method for assisting a user with capturing a video of an activity, the method being performed in a computerized system comprising a central processing unit, a camera, a memory and an audio recording device, the computer-implemented method comprising:
a. using the camera to capture the video of the activity;
b. using the central processing unit to process the captured video, the processing comprising determining a number of user's hands appearing in the captured video;
c. using the recording device to capture of the audio associated with the activity;
d. using the central processing unit to process the captured audio, the processing comprises determining a number of predetermined references in the captured audio;
e. using the determined number of user's hands appearing in the captured video and the determined number of predetermined references in the captured audio to generate feedback to the user; and
f. providing the generated feedback to the user using a notification.

2. The computer-implemented method of claim 1, wherein the computerized system further comprises a display device and wherein the generated feedback is provided to the user by displaying the generated feedback on the display device.

3. The computer-implemented method of claim 1, wherein the computerized system further comprises a display device, the display device displaying a user interface, the user interface comprising a live stream of the capturing video and the generated feedback interposed over the live stream.

4. The computer-implemented method of claim 1, wherein the computerized system further comprises an audio playback device and wherein the generated feedback is provided to the user using the audio playback device.

5. The computer-implemented method of claim 1, wherein the processing of the captured audio comprises performing speech recognition in connection with the captured audio.

6. The computer-implemented method of claim 1, wherein the feedback comprises the determined number of user's hands appearing in the captured video.

7. The computer-implemented method of claim 1, wherein the feedback comprises an indication of an absence of the predetermined references in the captured audio.

8. The computer-implemented method of claim 1, further comprising determining a confidence level of the determination of the number of user's hands appearing in the captured video, wherein a strength of the notification is based on the determined confidence level.

9. The computer-implemented method of claim 1, wherein the processing of the captured audio comprises performing a speech recognition in connection with the captured audio and wherein the method further comprises determining a confidence level of the speech recognition, wherein a strength of the notification is based on the determined confidence level.

10. The computer-implemented method of claim 1, wherein when it is determined that no user's hands appear in the captured video, the feedback comprises a last known location of at least one of the user's hands.

11. The computer-implemented method of claim 1, wherein when it is determined that no user's hands appear in the captured video, the feedback comprises an indication of absence of user's hands in the captured video.

12. The computer-implemented method of claim 1, wherein when it is determined that no user's speech is recognized in the captured audio, the feedback comprises an indication of absence of user's speech in the captured audio.

13. The computer-implemented method of claim 1, wherein when it is determined that no user's hands appear in the captured video and user's speech is recognized in the captured audio, the feedback comprises an enhanced indication of absence of user's hands in the captured video.

14. The computer-implemented method of claim 1, wherein when it is determined that at least one of user's hands appears in the captured video and no user's speech is recognized in the captured audio, the feedback comprises an enhanced indication of absence of user's speech in the captured audio.

15. The computer-implemented method of claim 1, wherein the camera is a depth camera producing depth information and wherein the number of user's hands appearing in the captured video is determined based, at least in part, on the depth information produced by the depth camera.

16. The computer-implemented method of claim 15, wherein determining the number of user's hands appearing in the captured video comprises:
i. applying a distance threshold to the depth information produced by the depth camera;
ii. performing a Gaussian blur transformation of the thresholded depth information;
iii. applying a binary threshold to the blurred depth information;
iv. finding hand contours; and
v. marking hand centroids from the found hand contours.

17. The computer-implemented method of claim 16, wherein the determining the number of user's hands appearing in the captured video further comprises marking hand sidedness.

18. The computer-implemented method of claim 16, wherein the determining the number of user's hands appearing in the captured video further comprises estimating fingertip positions.

19. The computer-implemented method of claim 18, wherein the estimating fingertip positions comprises: finding a convex hull of each hand contour; determining convexity defect locations; computing k-Curvature for each defect; determining a set of fingertip position candidates and clustering the fingertip position candidates to estimate the fingertip positions.

20. A non-transitory computer-readable medium embodying a set of computer-executable instructions, which, when executed in a computerized system comprising a central processing unit, a camera, a memory and an audio recording device, cause the computerized system to perform a method for assisting a user with capturing a video of an activity, the method comprising:
a. using the camera to capture the video of the activity;
b. using the central processing unit to process the captured video, the processing comprising determining a number of user's hands appearing in the captured video;
c. using the recording device to detect an audio associated with the activity; and
d. providing a feedback to the user when the determined number of user's hands decreases while the audio continues to be detected.

21. A computerized system for assisting a user with capturing a video of an activity, the computerized system comprising a central processing unit, a camera, a memory and an audio recording device, the memory storing a set of instruction for:
a. using the camera to capture the video of the activity;
b. using the central processing unit to process the captured video, the processing comprising determining a number of user's hands appearing in the captured video;
c. using the recording device to capture of the audio associated with the activity;
d. using the central processing unit to process the captured audio, the processing comprises determining a number of predetermined references in the captured audio;
e. using the determined number of user's hands appearing in the captured video and the determined number of predetermined references in the captured audio to generate feedback to the user; and
f. providing the generated feedback to the user using a notification.
